(19) United States
(12) Patent Application Publication
(10) Pub. No.: US 2008/0292386 A1
(43) Pub. Date: Nov. 27, 2008

(54) COSMETICS APPLIANCE

(76) Inventor: Young Gu LEE, Anyang City (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/828,126

(22) Filed: Jul. 25, 2007

(30) Foreign Application Priority Data
May 25, 2007 (KR) 10-2007-0050793
Jun. 20, 2007 (KR) 10-2007-0060477

(51) Int. Cl. B43K 5/00

(52) U.S. Cl. 401/202; 401/205

(57) ABSTRACT

Disclosed is a cosmetics appliance that has a unitary structure in which a container and an applicator are coupled to each other. The cosmetics appliance includes an open/close mechanism in which discharging orifices of a cosmetics appliance are opened/closed in response to the fitting and releasing operation of a container cap. The cosmetics appliance includes a holder which is moved along with an opening/closing section toward the container when the container cap is fitted to the container. This configuration allows a simplified structure and stable operation.

### BACKGROUND OF THE INVENTION

1. Field of the Invention

The present invention relates to a cosmetics appliance, and more particularly to a cosmetics appliance in which a storage vessel holding a cosmetic product in liquid state or powder and an applicator for application of the cosmetic product are coupled to be in a unitary structure.

2. Description of the Prior Art

Since it is inconvenient to store and use a cosmetic product when an applicator for application of a cosmetic product is separated from a storage vessel for holding the cosmetic product, cosmetics appliances that have a unitary structure of a container and an applicator coupled together have been developed and utilized.

FIGS. 16 and 17 are assembled cross sectional views of a conventional cosmetics appliance, respectively, FIG. 18 is an exploded perspective view of the conventional cosmetics appliance, FIG. 19 is a perspective view of the holder section shown FIG. 18, FIG. 20 is a partially cut perspective view of the nozzle shown FIG. 18, FIG. 21 is a cross sectional perspective view of the container cap shown in FIG. 18, and FIGS. 22 and 23 are views of the conventional cosmetics appliance, illustrating how the cosmetics appliance is assembled, respectively.

A conventional cosmetics appliance has, as shown in these drawings, a container 110, a holder 130 arranged at the upper side of the container 110, an applicator 181 connected to the holder 130, a nozzle 150 connected on the upper surface of the container 110, a container cap 160 to be connected to the container 110, and an opening/closing section 170 which opens/closes a flow path between the nozzle 150 and the holder 130 in response to the fitting and releasing operations of the container cap 160.

The container 110 includes a storage vessel 111 having a generally oval-shaped cross section, and a shoulder 112 in the shape of a ring and connected at the upper end of the storage vessel 111.

The storage vessel 111 has a hill portion 111a formed at the central area of the upper surface thereof, and the hill portion 111a has a pair of engaging ribs 111b formed to extend outwardly from the upper end thereof.

Then, the hill portion 111a has an outflow tube 111c formed at the central area thereof. The outflow tube 111c has an upper opening serving as an outflow exit 111d through which the cosmetic product being stored in the storage vessel 111 flows out.

The shoulder 112 has a pair of elongated holes 112b formed opposite to each other, and has blocking sills 112c formed at each of the areas below each of the elongated holes 112b of the inner surface thereof.

The shoulder 112 having the configuration above is connected to the hill portion 111a by pressing the shoulder 112 toward the storage vessel 111 so that the blocking sills 112c go beyond the engaging ribs 111b.

The holder 130 has its inner space divided into an upper region and a lower region by a separating plate 132, and has an acting sill 137 formed on the outer surface thereof.

The holder 130 has a tapered surface at an area above the acting sill 137 so that the cross section of the holder 130 is gradually decreased from the acting sill 137.

The holder 130 has, at its upper end, an applicator inserting opening 133 formed to be connected with discharging orifices 130a described below.

The holder 130 has, at the area below the separating plate 132, a pair of guiding elongated holes 134 opposite each other.

Then, the holder 130 has the discharging orifices 130a and a nozzle inserting recess 131, which are connected with each other.

The nozzle inserting recess 131 includes a body seating recess 131a and a protrusion seating recess 131b, which are continuously formed at upper and lower sides of the nozzle inserting recess 131 and are integrally connected with each other.

Then, the separating plate 132 has, on its bottom surface, two pairs of supporting pillars 135 and a pair of guiding walls 136. The supporting pillars 135 and the guiding walls 136 are disposed in a cross-shape.

The holder 130 having the configuration above is arranged in such a manner that the each of hook walls 173 are inserted into a respective one of the guiding elongated holes 134.

The applicator 181 is in the shape of a brush and is mounted to the applicator inserting opening 133.

The nozzle 150 includes a nozzle body 151 having a discharging aperture 151a at the upper end and an inlet aperture 151b at the lower end thereof, a supporting flange 52 formed on the outer surface of the nozzle body 151, and a guiding protrusion 153 formed at the upper end of the nozzle body 151.

The nozzle body 151 is designed to have a circular cross section throughout the entire length.

The nozzle 150 having the configuration above is assembled in such a manner that the lower portion of the nozzle body 151 is inserted into the outflow tube 111c, the upper portion of the nozzle body 151 is inserted into the body seating recess 131a, and the guiding protrusion 153 is inserted into the protrusion seating recess 131b. Accordingly, the inlet aperture 151b is connected with the outflow exit 111d, and the discharging aperture 151a is closed in respect to the protrusion seating recess 131b.

The container cap 160 has a diameter expander 161 formed at the lower end of its inner surface, and has a pressing edge 164 which is provided by the diameter expander 161 and is formed at the inner surface of the container cap 160.

The diameter expander 161 has a pair of hook slits 162, each formed corresponding to a respective one of the guiding elongated holes 134 of the holder 130.

The container cap 160 having the configuration above is assembled in such a manner that each of the curved portions 173a of the hook walls 173 are inserted into a respective one of the hook slits 162. Accordingly, the container cap 160 forms an airtight space 166 in cooperation with the container 110.

The opening/closing section 170 includes a support ring 171 in the shape of an oval, a pair of engaging plates 172 formed in the support ring 171 so as to extend outwardly, a pair of engaging walls, each formed corresponding to a respective one of the engaging plates 172, and two pairs of returning elastic bars 174 formed in the support ring 171 so as to be directed inward.

Each of the hook walls 173 has a bent upper end and extending in parallel with a corresponding engaging plate 172 from the hook wall.

Each of the returning elastic bars 174 is supported at each of the supporting pillars 135.

Hereinafter, an open/close mechanism in which the opening/closing section 170 having the configuration above opens/closes the flow path between the nozzle 150 and the holder 130 in response to an opening/closing operation of the container cap 160 will be explained with reference to FIGS. 24 to 30.

The close mechanism in which the flow path between the nozzle 150 and the holder 130 is closed when the container cap 160 is fitted to the container 110 will be explained as follows.

The container cap 160 is pressed toward the storage vessel 111 so that the applicator 181 is moved into the container cap 160 (see FIGS. 24 and 25).

When the container cap 160 is pressed, the lower end of the container cap 160 presses the hook walls 173 (see FIG. 26).

When the hook walls 173 are pressed, the support ring 171 is compressed and deformed so as to allow hook slit lower areas 163 of the container cap 160 to go beyond the hook walls 173.

When the hook slit lower areas 163 of the container cap 160 have gone beyond the hook walls 173, the hook slit lower areas 163 are interposed between the shoulder 112 and the hook walls 173, and the container cap 160 is fitted to the container 110 (see FIG. 27).

Meanwhile, since the acting sill 137 is pressed by the pressing edge 164 when the container cap 160 is pressed toward the storage vessel 111, the holder 130 is approached to the nozzle 150 (see FIG. 28).

While the holder 130 is approaching the nozzle 150, elastic force is accumulated in the returning elastic bars 174 (see FIG. 28).

When the holder 130 continues to approach the nozzle 150, the guiding protrusion 153 enters the protrusion seating recess 131b and the discharging aperture 151a is closed in respect to the protrusion seating recess 131b (see FIGS. 29 and 30).

Next, the open mechanism in which the flow path between the nozzle 150 and the holder 130 is opened when the container cap 160 is released from the container 110 will be explained as follows.

When the container cap 160 is pressed in a direction to bring the pair of the engaging plates 172 closes to each other, the support ring 171 is compressed and deformed to allow the hook slit lower areas 163 of the container cap 160 to go beyond the hook walls 173.

The container cap 160 is then pulled in a direction away from the storage vessel 111 in the deformed state of the support ring 171.

When the container cap 160 is pulled away from the storage vessel 111, the hook slit lower areas 163 escape from between the shoulder 112 and the hook walls 173, and thus the container cap 160 is released from the container 110.

Meanwhile, when the container cap 160 is pulled to move away from the storage vessel 111, the holder 130 is moved by the elastic force accumulated in the returning elastic bars 174 to be away from the nozzle 150.

When the holder 130 has been pulled away from the nozzle 150, the guiding protrusion 153 escapes from the protrusion seating recess 131b, and the discharging aperture 151a is opened in respect to the protrusion seating recess 131b.

The conventional cosmetics appliance described above may be used as follows. It is supposed for the sake of convenience of explanation that there is a cosmetic product stored in the liquid state or in the form of powder within the storage vessel 111, and that the cosmetics appliance is in its assembled state.

The user removes the container cap 160 from the container 110 first. When the container cap 160 is removed from the container 110, the discharging aperture 151a is opened in respect to the protrusion seating recess 131b.

When the discharging aperture 151a has been opened in respect to the protrusion seating recess 131b, the cosmetic product stored in the storage vessel 111 passes through the outflow exit 111d, discharging aperture 151a, and discharging orifices 130a, sequentially, and then is delivered to the applicator 181.

The delivered cosmetic product in the applicator 181 is then contacted to the desired area of the human body by the user so as to be applied to the desired area.

After the cosmetic product is applied to the desired area of the human body, the user fits the container cap 160 to the container 110 again.

Meanwhile, when the cosmetic product in the storage vessel 111 has been used up, the storage vessel 111 can be refilled with additional cosmetic product for use by releasing the container cap 160, holder 130, and nozzle 150, enabling the additional cosmetic product to be replaced in the storage vessel 111 again.

However, according to the conventional cosmetics appliance, the opening/closing section 170 is designed to be maintained in a stationary state, but the holder 130 is designed to approach the opening/closing section 170, which results in the following problems.

First, the structure of the holder is complicated because the supporting pillars 135 for supporting the returning elastic bars 174 should be formed at the holder 130.

Second, the durability of the opening/closing section 170 is decreased because the support ring 171 is deformed whenever the holder 130 approaches and moves away from the opening/closing section 170, and the returning elastic bars 174 is incorporated to the support ring 171.

Third, the movement operation of the holder 130 can not be stably maintained because the support ring 171 is deformed whenever the holder 130 approaches and moves away from the opening/closing section 170.

### SUMMARY OF THE INVENTION

Accordingly, the present invention has been made to solve the above-mentioned problems occurring in the prior art, and the present invention provides a cosmetics appliance in which an opening/closing section, along with a holder, approaches a container when a container cap is fitted to a container.

In order to accomplish the aspect of the present invention, there is provided a cosmetics appliance which includes: a container having a storage vessel and a shoulder connected at an upper end of the storage vessel, the storage vessel having an outflow exit formed on a top surface thereof, the shoulder being in the shape of a ring; a holder having discharging orifices and a nozzle inserting recess, the discharging orifices and the nozzle inserting recess being formed to connect with one another, wherein the holder is disposed in such a manner that the nozzle inserting recess is directed toward the outflow exit; an applicator connected to the holder in such a manner to receive a cosmetic product being discharged through the discharging orifices; a nozzle having a discharging aperture and an inlet aperture, the discharging aperture and the inlet aperture being connected with each other, wherein the nozzle is disposed in such a manner that the inlet aperture is connected with outflow exit and the discharging aperture is opened in respect to the nozzle inserting recess; a container cap fitted to the container in such a manner that the container cap forms an airtight space in cooperation with the container; and an opening/closing section operable to move the holder toward the nozzle when the container cap is fitted to the container, so that the discharging aperture is closed in respect to the nozzle inserting recess, and operable to return the holder when the container cap is released from the container, so that the discharging aperture is opened in respect to the nozzle inserting recess, wherein the shoulder has a release preventing rib formed inwardly from an upper end of an inner surface thereof, wherein the container cap has pressing pillars formed on an inner surface thereof, so that the container cap is operable to press the holder toward the storage vessel when the container cap is fitted to the container, wherein the opening/closing section has a movable plate and returning springs, the movable palate disposed below the release preventing rib and having a nozzle insert hole formed at a central area thereof, the movable plate being connected to the holder so that the movable plate is operable to move toward the storage vessel along with the holder when the holder is pressed by the container cap, the returning springs being interposed between the movable plate and the storage vessel so that the returning springs are operable to be deformed while accumulating elastic force when the movable plate moves toward the storage vessel.

It is preferred that the movable plate has spring holes formed vertically on an upper surface thereof, each of the spring holes supporting a respective one of returning springs so that the movement operation of the returning springs can be stably maintained.

It is also preferred that the holder includes a holder body having the discharging orifices and the nozzle inserting recess formed therein, a shape retaining plate formed at an upper end of the holder body, and a connecting member removably connected to the holder body in a manner to permit an applicator fixing gap to be formed between the connecting member and the holder body, wherein the applicator is in the shape of a cap and is secured to the applicator fixing gap while being supported by the shape retaining plate so that the condition of the applicator installation can be stably maintained.

It is also preferred that the discharging orifices are formed so as to allow a cosmetic product to be discharged through one surface of the holder body so that a loss of cosmetic product can be reduced.

It is also preferred that the nozzle includes a nozzle body and a guiding protrusion formed at the upper end of the nozzle body, the nozzle body having the discharging aperture formed at an upper end thereof and the inlet aperture formed at a lower end thereof, wherein the nozzle inserting recess is formed to be sectioned into a protrusion seating recess and a body seating recess, wherein the holder body is formed in such a manner that an outer surface area having the discharging orifices is higher than an outer surface area having the body seating recess based on a plate surface of the shape retaining plate so that the cosmetic product having been passed through the discharging orifices can be delivered to the applicator in a much larger amount.

It is also preferred that the shape retaining plate has, at each of either side areas of the nozzle inserting recess, a respective one of flow preventing walls for preventing the cosmetic product discharged through the discharging orifices from flowing down toward a lower end of the holder body so that the cosmetic product having been passed through the discharging orifices can be delivered to the applicator in a much larger amount.

It is also preferred that the pressing pillars are formed to form an inner airtight space around the applicator in cooperation with the holder so that the remaining cosmetic product in the applicator can be prevented from hardening.

### BRIEF DESCRIPTION OF THE DRAWINGS

The above and other objects, features and advantages of the present invention will be more apparent from the following detailed description taken in conjunction with the accompanying drawings, in which:

FIG. 1 is an assembled perspective view of a cosmetics appliance according to one embodiment of the present invention;

FIGS. 2 and 3 are cross sectional views of the cosmetics appliance according to one embodiment of the present invention, respectively;

FIG. 4 is an exploded perspective view of the cosmetic appliance according to one embodiment of the present invention;

FIG. 5 is a perspective view of the holder section shown in FIG. 4;

FIG. 6 is a partially cut perspective view of the nozzle shown in FIG. 4;

FIG. 7 is a cross sectional perspective view of the container cap shown in FIG. 4;

FIG. 8 is a view of the cosmetics appliance according to one embodiment of the present invention, illustrating how the cosmetics appliance is assembled;

FIGS. 9 to 12 are views of the cosmetics appliance according to one embodiment of the present invention, illustrating operations of fitting the container cap to a container;

FIGS. 13 and 14 are cross sectional views of a container cap according to another embodiment of the present invention, respectively;

FIG. 15 is a cross sectional view of the cosmetics appliance according to another embodiment of the present invention, in which the container cap is fitted to the container;

FIGS. 16 and 17 are assembled cross sectional views of a conventional cosmetics appliance, respectively;

FIG. 18 is an exploded perspective view of the conventional cosmetics appliance;

FIG. 19 is a perspective view of the holder section shown FIG. 18;

FIG. 20 is a partially cut perspective view of the nozzle shown FIG. 18;

FIG. 21 is a cross sectional perspective view of the container cap shown in FIG. 18;

FIGS. 22 and 23 are views of the conventional cosmetics appliance, illustrating how the cosmetics appliance is assembled, respectively; and

FIGS. 24 to 30 are views of the conventional cosmetics appliance, illustrating the operation of fitting the container cap to the container.

### DETAILED DESCRIPTION OF THE EXEMPLARY EMBODIMENTS

Hereinafter, an exemplary embodiment of the present invention will be described with reference to the accompanying drawings. In the following description and drawings, the same reference numerals are used to designate the same or similar components, and so repetition of the description on the same or similar components will be omitted.

Hereinafter, the present invention will be described in greater detail with reference to the accompanying drawings.

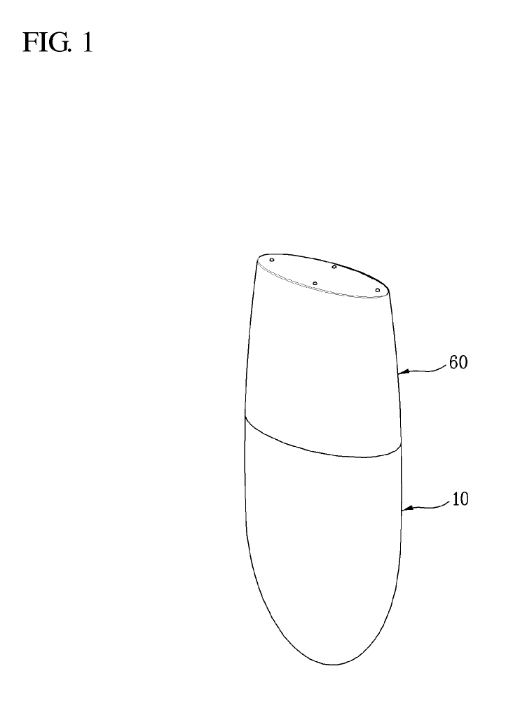

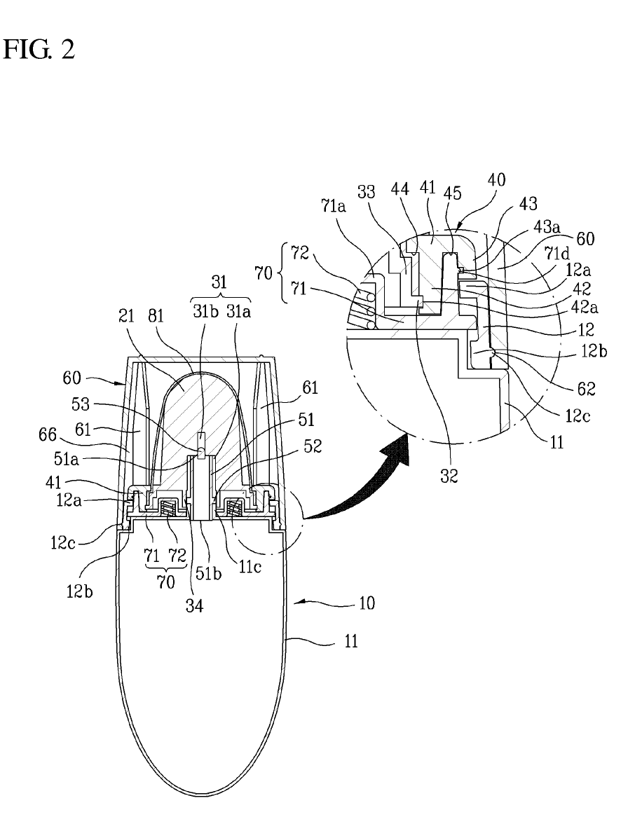

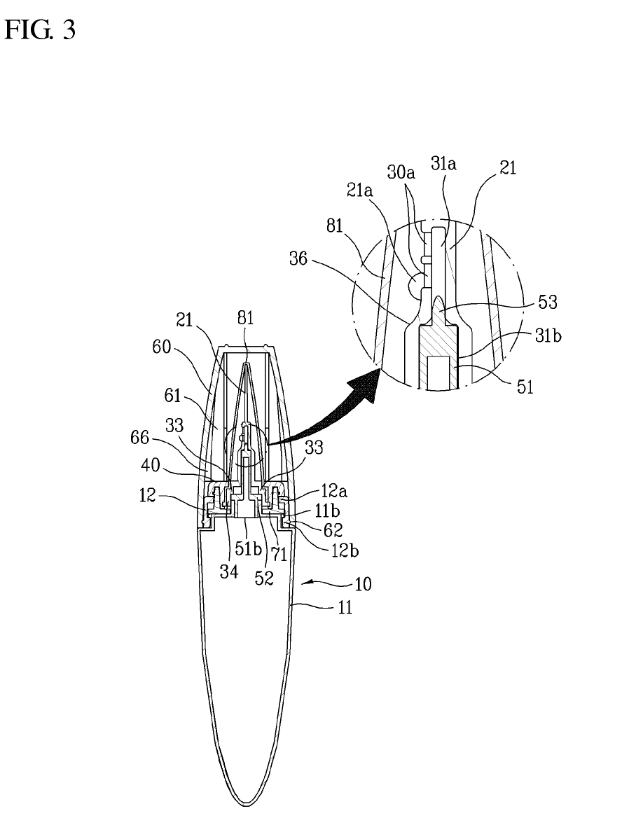

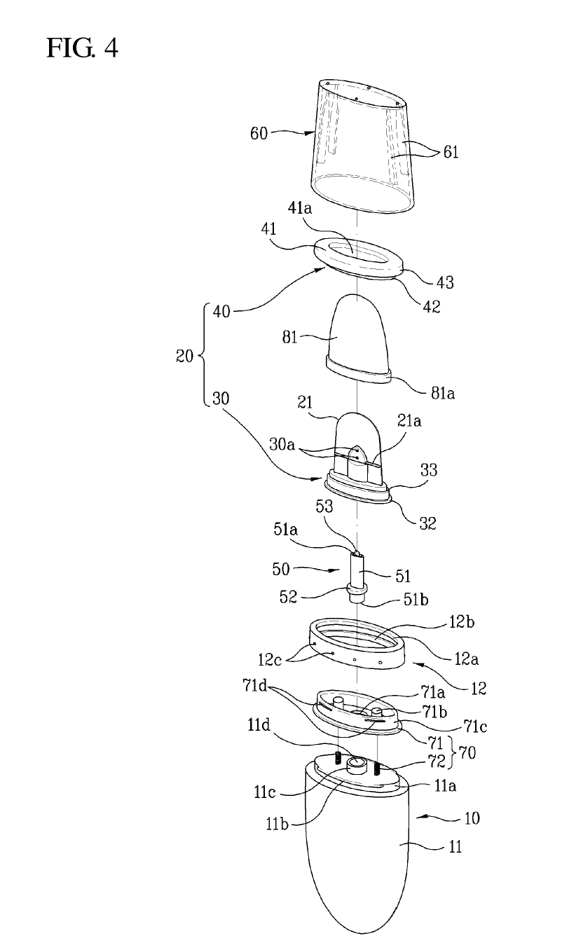

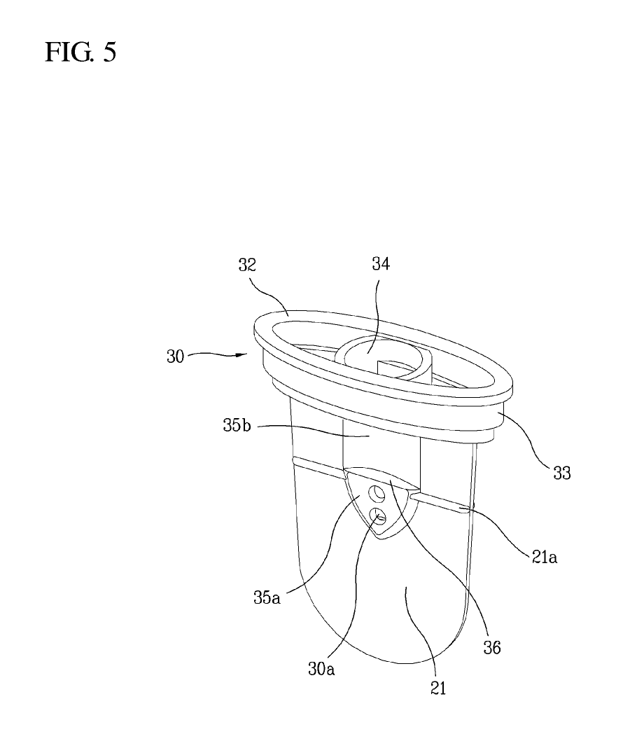

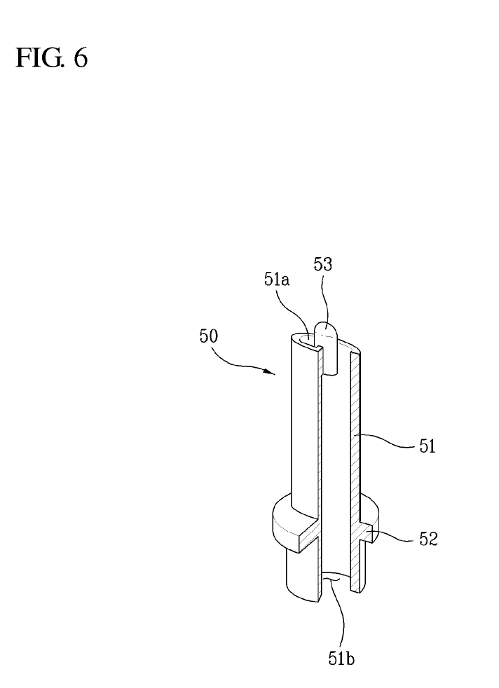

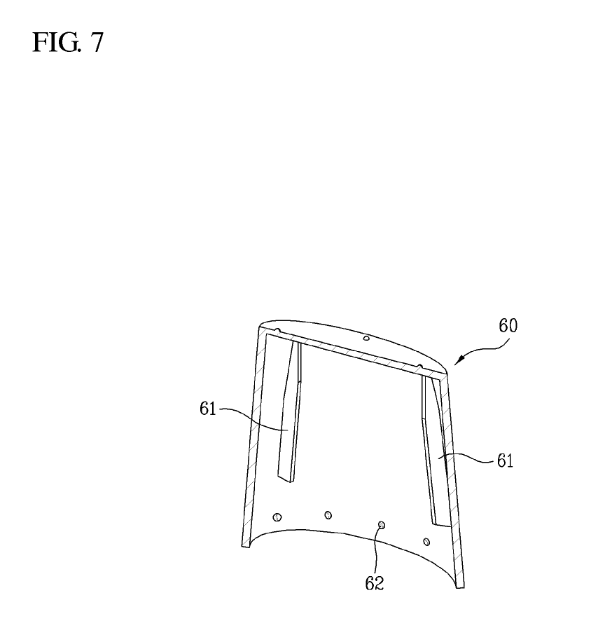

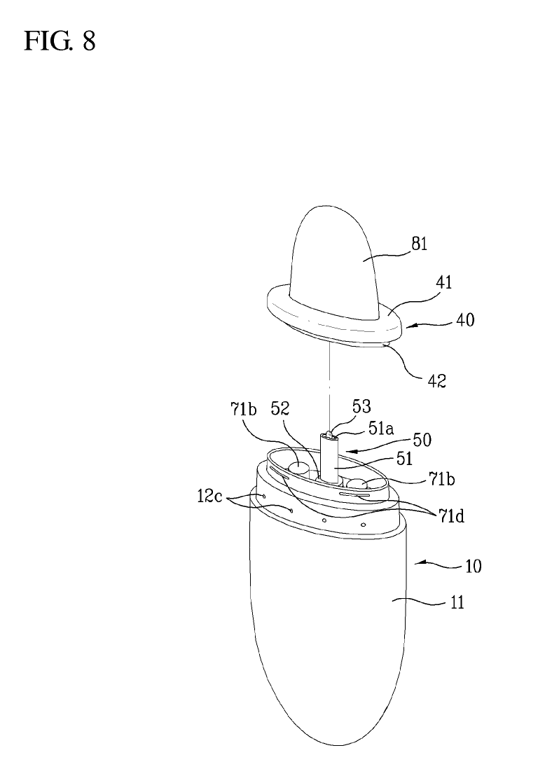

FIG. 1 is an assembled perspective view of a cosmetics appliance according to one embodiment of the present invention, FIGS. 2 and 3 are assembled cross-sectional views of the cosmetics appliance according to one embodiment of the present invention, respectively, FIG. 4 is an exploded perspective view of the cosmetics appliance according to one embodiment of the present invention, FIG. 5 is a perspective view of the holder section shown in FIG. 5, FIG. 6 is a perspective view of the nozzle shown in FIG. 4, FIG. 7 is a cross sectional view of the container cap shown in FIG. 4, and FIG. 8 is a view illustrating how the cosmetics appliance according to one embodiment of the present invention is assembled.

A cosmetics appliance according to one embodiment of the present invention includes, as shown in those drawings, a container 10, a holder 20 arranged in an upper side of the container 10, an applicator 81 connected to the holder 20, a nozzle 50 connected on a upper surface of the container 10, a container cap 60 to be fitted to the container 10, and an opening/closing section 70 opening and closing a flow path between the nozzle 50 and the holder 20, in response to the fitting and releasing operations of the container cap 60.

The container 10 includes a storage vessel 11 having a generally oval-shaped cross-section and a shoulder 12 in the shape of a ring, and is connected at an upper end of the storage vessel 11.

The storage vessel 11 has a hill portion 11a formed at a central area of an upper surface thereof, and the hill portion 11a has, on its upper end, a pair of engaging ribs 11b protruding outwardly.

There is formed an outflow tube 11c at a central area of the hill portion 11a. The outflow tube 11c has a top end opening serving as an outflow exit 11d through which a cosmetic product being held in the storage vessel 11 flows out.

The storage vessel 11 may be made from flexible material, such as Low Density Polyethylene (LDPE).

The shoulder 12 has a release preventing rib 12a formed to extend inwardly from an upper end of its inner surface and a hooking rib 12b formed on lower end of its inner surface.

The shoulder 12 has also a plurality of cap connecting protrusions 12c formed on an outer surface thereof.

The holder 20 includes a holder body 30 having a generally inverted “T” shape, a shape retaining plate 21 having a generally inverted “U” shape disposed on an upper end of the holder body 30, and a connecting member 40 removably connected to the holder body 30.

The holder body 30 has discharging orifices 30a connected with a nozzle inserting recess 31.

The nozzle inserting recess 31 includes a protrusion seating recess 31b and a body seating recess 31a, which are continuously formed at upper and lower sides of the nozzle inserting recess 131 and are integrally connected with each other.

The body seating recess 31a has a cross section larger than that of the protrusion seating recess 31b.

The holder body 30 has a connecting flange 32 formed at a lower end and throughout the entire periphery thereof. The holder body 30 has a fixing gap step portion 33 formed above the connecting flange 32 of an outer surface thereof.

The holder body 30 also has a nozzle guiding tube 34 formed in a lower area of the body seating recess 31a.

The holder body 30 has also a sloping surface 36 formed between an outer surface area 35a where the discharging orifices 30a is formed and an outer surface area 35b where the body seating recess 31a is formed. Accordingly, the outer surface area 35a having the discharging orifices 30a is higher than the outer surface area 35b having the body seating recess 31a, based on the plate surface of the shape retaining plate 21.

The shape retaining plate 21 has, in areas of either sides of the nozzle inserting recess 31, flow preventing walls 21a formed parallel to the connecting flange 32.

The sloping surface 36 and the flow preventing walls 21a can prevent a cosmetic product having passed through the discharging orifices 30a from flowing down toward a lower end of the holder body 30, which enables much more amount of the cosmetic product, having passed through the discharging orifices 30a, to be delivered to the applicator 81.

The shape retaining plate 21 may be made from flexible material, such as Low Density Polyethylene (LDPE).

The connecting member 40 includes an acting plate 41 having a body hole 41a at a central area thereof, and a engaging inner wall 42 and a engaging outer wall 43, in which the engaging inner wall 42 and the engaging outer wall 43 are formed on a bottom surface of the acting plate 41 so as to form two concentric circles.

The engaging inner wall 42 has a body connecting groove 42a formed on its inner surface and along its inner periphery.

The engaging outer wall 43 has rib engaging recesses 43a formed on its inner surface.

There is formed a wall engaging groove 45 between the engaging outer wall 43 and the engaging inner wall 42.

The connecting member 40 having the configuration above is secured to the holder body 30 by press-fitting the connecting flange 32 into the body connecting groove 42a.

When the connecting member 40 has been connected to the holder body 30, an applicator fixing gap 44 is formed between the fixing gap step portion 33 and the engaging outer wall 43.

The applicator 81 may be made from porous material, such as a urethane sponge, and is formed in the shape of a cap. The applicator 81 has a fixing flange 81a formed at a lower end thereof.

The applicator 81 having the configuration above is assembled in such a manner that the fixing flange 81a is inserted into the applicator fixing gap 44 while the applicator 81 is supported by the shape retaining plate 21.

The nozzle 50 includes a nozzle body 51 having a discharging aperture 51a at its upper end and an inlet aperture 51b at its lower end, a supporting flange 52 formed on an outer surface of the nozzle body 51, and a guiding protrusion 53 formed at an upper end of the nozzle body 51.

The nozzle body 51 is designed to have a lower portion of a circular cross section below the supporting flange 52 and an upper portion of an oval cross section above the supporting flange 52.

The nozzle 50 having the configuration above is assembled in such a manner that the lower portion of the nozzle body 51 is inserted into the outflow tube 11c, the upper portion of the nozzle body 51 is inserted into the body seating recess 31a, and the guiding protrusion 53 is inserted into the protrusion seating recess 31b. As a result, the inlet aperture 51b is connected with the outflow exit 11d, and the discharging aperture 51a is closed in respect to the protrusion seating recess 31b is closed.

The container cap 60 has, on an inner surface of its lower end, container connecting recesses 62 corresponding to the cap connecting protrusions 12c, and has four pressing pillars 61 formed above the container connecting recesses 62.

Each of the four pressing pillars 61 is designed to press down on the connecting member 40 toward the storage vessel 11 as the container cap 60 is fitted to the container 10.

The container cap 60 having the configuration above is assembled in such a manner that the cap connecting protrusions 12c are inserted into the container connecting recesses 62.

The opening/closing section 70 includes a movable plate 71 to be connected to the holder 20 and returning springs 72 interposed between the movable plate 71 and the storage vessel 11.

The movable plate 71 has a nozzle insert hole 71a at a central area thereof, and has a pair of spring holes 71b formed vertically on an upper surface thereof.

Then, the movable plate 71 has a holder connecting wall 71c formed on the upper surface thereof, and the holder connecting wall 71c has holder connecting ribs 71d formed on an outer surface thereof.

The movable plate 71 having the configuration above is connected to the connecting member 40 as follows.

At first, the movable plate 71 is inserted through a lower opening of the shoulder 12.

Then, the holder connecting wall 71c is inserted into the wall engaging groove 45 so that the holder connecting ribs 71d are respectively engaged with each of the rib engaging recesses 43a.

Once having been connected to the connecting member 40, the movable plate 71, together with the holder 20, comes to be able to move toward the storage vessel 11. Then, the movable plate 71 is prevented by the release preventing rib 12a from escaping from the shoulder 12.

The returning springs 72 is assembled in such a manner that both ends of the returning springs 72 are supported at the hill portion 11a and the spring holes 71b, respectively.

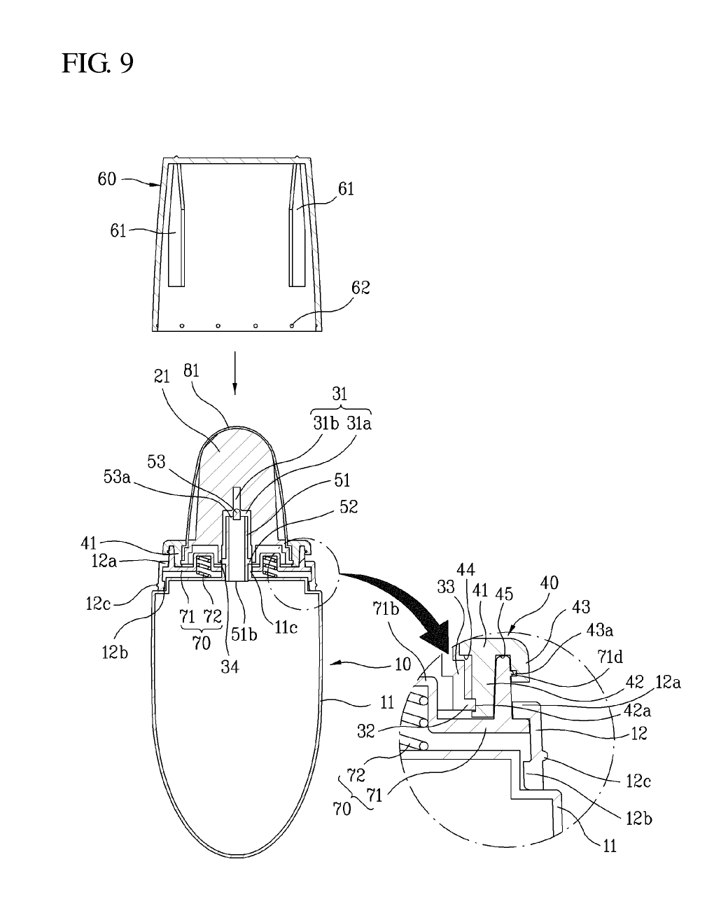

Hereinafter, an open/close mechanism in which the opening/closing section 70 opens/closes the flow path between the nozzle 50 and the holder 20 will be described with reference to FIGS. 9 to 12.

At first, a close mechanism in which the flow path is closed as the container cap 60 is fitted to the container 10 will be explained as follows.

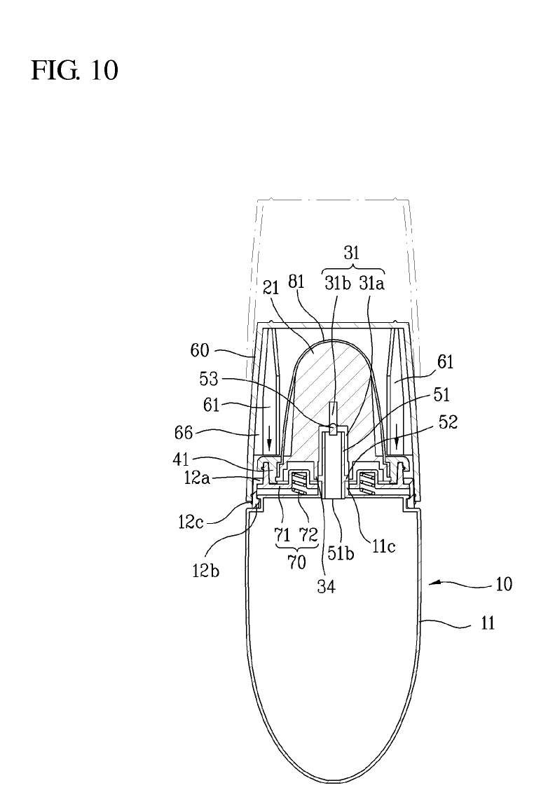

The container cap 60 is moved toward the storage vessel 11 so that the applicator 81 enters the inside of the container cap 60 (see FIGS. 9 and 10).

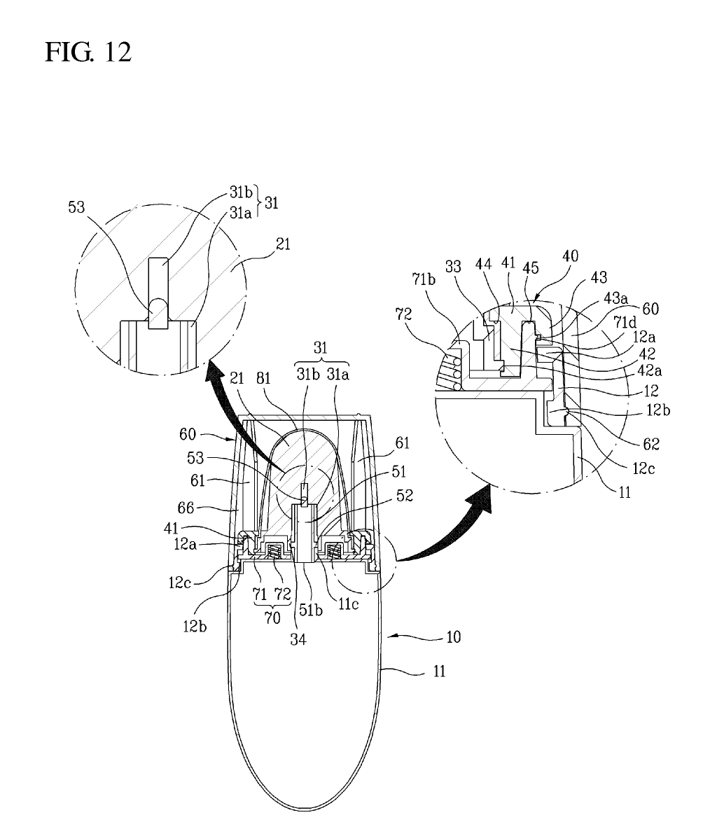

When the container cap 60 is pressed so that the cap connecting protrusions 12c are engaged with the container connecting recesses 62, the container cap 60 is fitted to the container 10 (see FIG. 12).

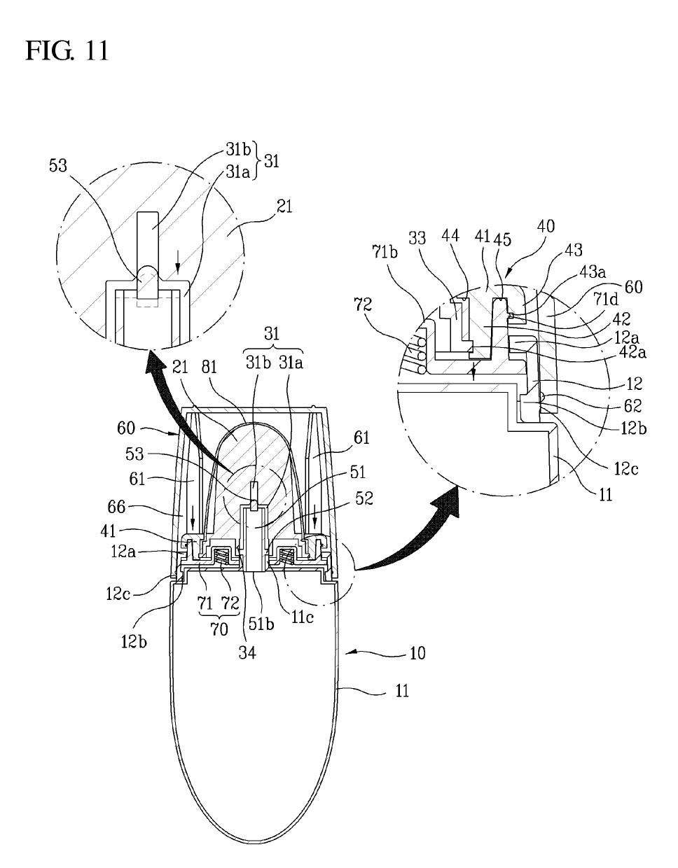

Meanwhile, since the connecting member 40 is pressed by the four pressing pillars 61 as the container cap 60 is pressed toward the storage vessel 11, the holder 20 approaches the nozzle 50 and the movable plate 71 approaches the storage vessel 11 (see FIG. 11).

While the movable plate 71 is approaching the storage vessel 11, elastic force is accumulated in the returning springs 72 (see FIG. 11).

When the holder 20 continues to approach the nozzle 50, the guiding protrusion 53 enters the protrusion seating recess 31b and the discharging aperture 51a is closed in respect to the protrusion seating recess 31b (see FIG. 12).

Next, an open mechanism in which the flow path is opened as the container cap 60 is removed from the container 10 will be explained as follows.

The container cap 60 is pulled in a direction away from the storage vessel 11.

When the container cap 60 is pulled away from the storage vessel 11, the cap connecting protrusions 12c escape from the container connecting recesses 62, and the container cap 60 is released from the container 10.

Meanwhile, while the container cap 60 is being pulled away from the storage vessel 11, the movable plate 71 moves away from the storage vessel 11 by the elastic force accumulated in the returning springs 72, and the holder 20 moves away from the nozzle 50.

When the holder 20 moves away from the nozzle 50, the guiding protrusion 53 escapes from the protrusion seating recess 31b and the discharging aperture 51a is opened in respect to the protrusion seating recess 31b.

The described cosmetics appliance according to one embodiment of the present invention may be used as follows. It is supposed for the sake of convenience of explanation that there is a cosmetic product stored in the liquid state or in the form of powder within the storage vessel 11, and that the cosmetics appliance is in its assembled state.

The user removes the container cap 60 from the container 10 first. When the container cap 60 is removed from the container 10, the discharging aperture 51a is opened in respect to the protrusion seating recess 31b.

Then, the user presses the storage vessel 11 when the discharging aperture 51a has been opened in respect to the protrusion seating recess 31b, so that the cosmetic product passes through the outflow exit 11d, discharging aperture 51a, protrusion seating recess 31b, and discharging orifices 30a, sequentially, and then is delivered to the applicator 81.

The delivered cosmetic product in the applicator 81 is then contacted to the desired area of the human body by the user so as to be applied to the desired area.

After the cosmetic product is applied to the desired area of the human body, the user fits the container cap 60 to the container 10 again.

Meanwhile, when the cosmetic product in the storage vessel 11 has been used up, the storage vessel 11 can be refilled with additional cosmetic product for use by that the container cap 60, holder 20, opening/closing section 70, and nozzle 50 are released, and the additional cosmetic product is then filled in the storage vessel 11 again. Here, the releasing of the holder 20 and the opening/closing section 70 can also be carried out while being assembled together.

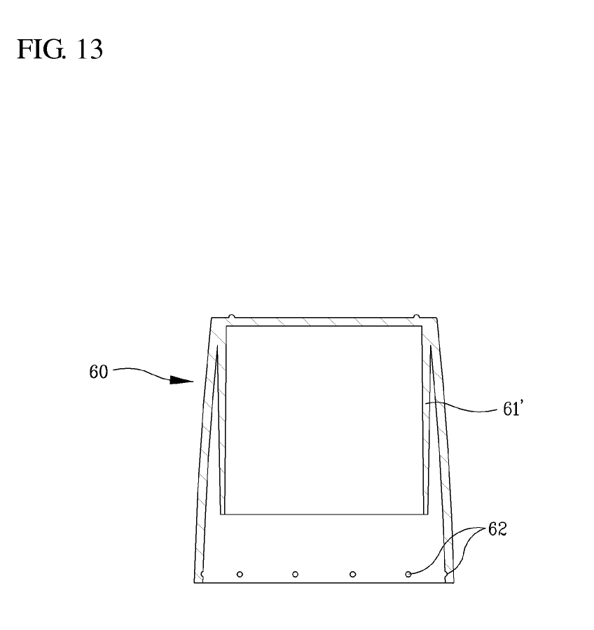

Meanwhile, although the pressing pillars 61 in the embodiment described above are designed to be a plurality of pillars which is divided into individual pillars, a pressing pillar 61′ as shown in FIGS. 13 to 15 can be employed so that it forms an airtight space 66 in cooperation with the container 10, as well as forms an inner airtight space 66a around the applicator 81, in cooperation with the holder 20.

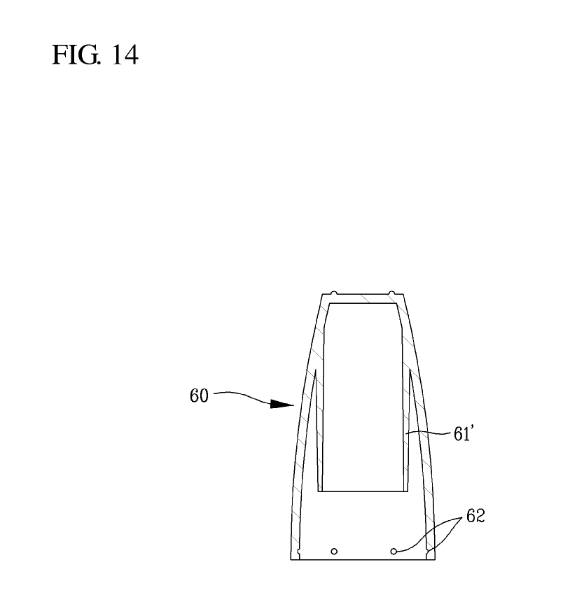

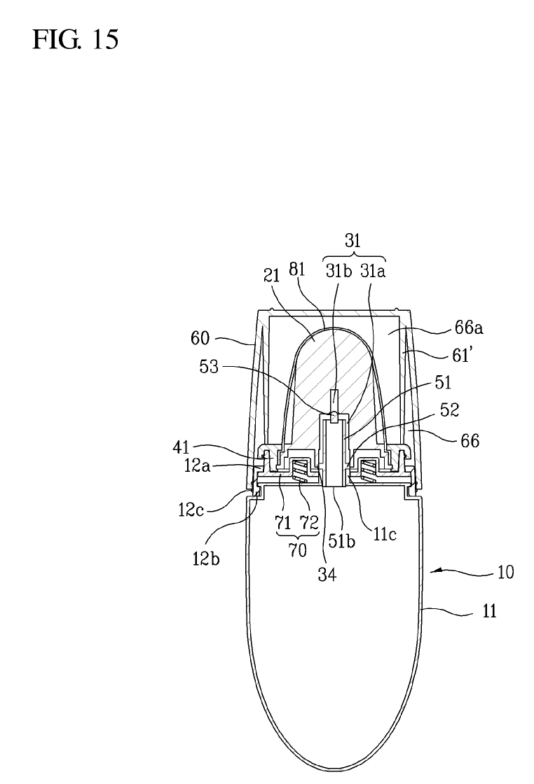

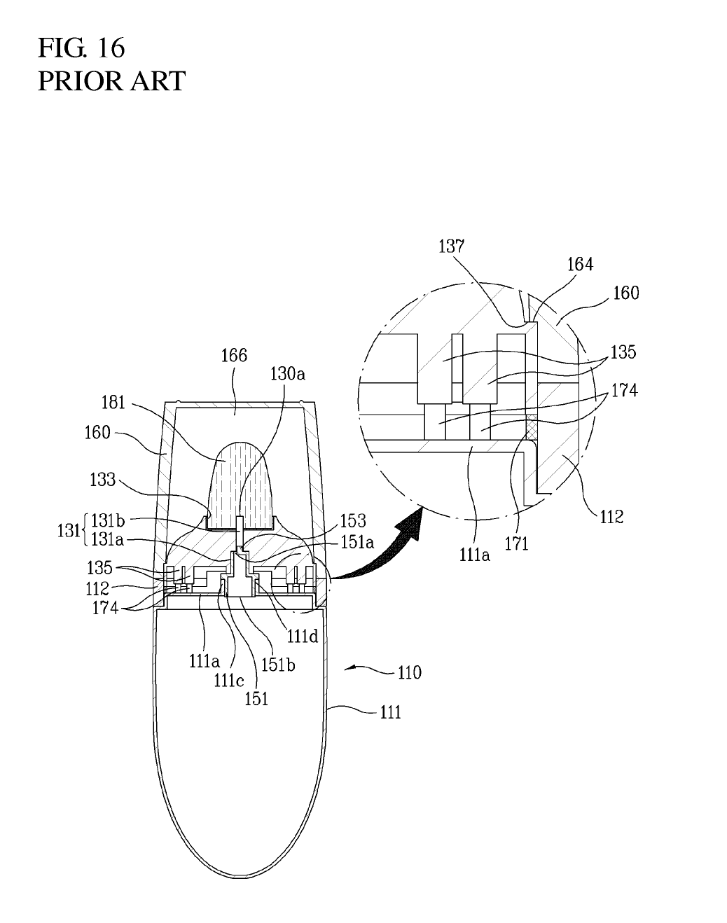

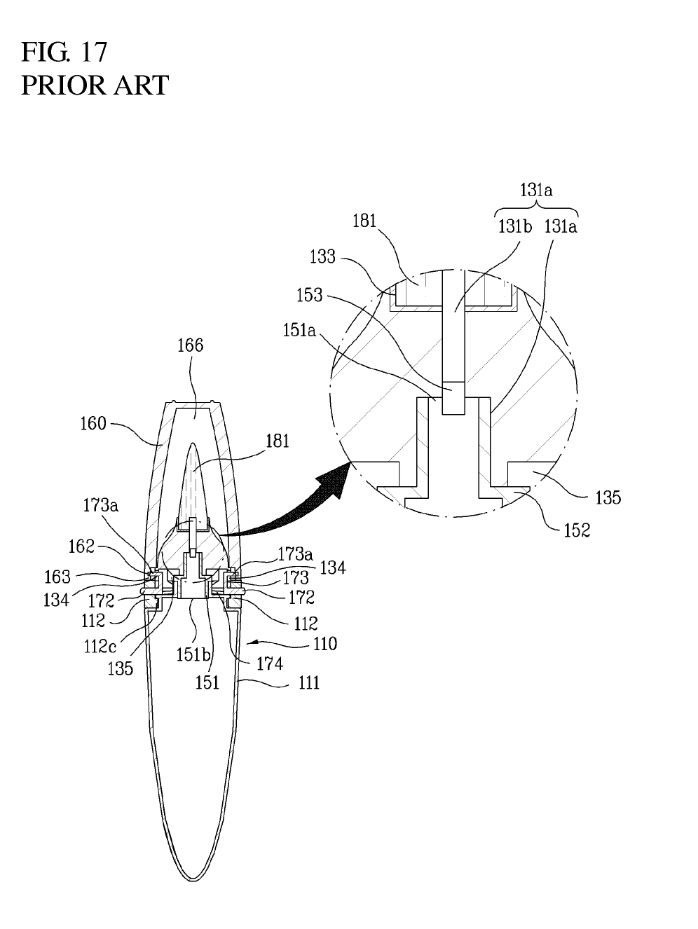

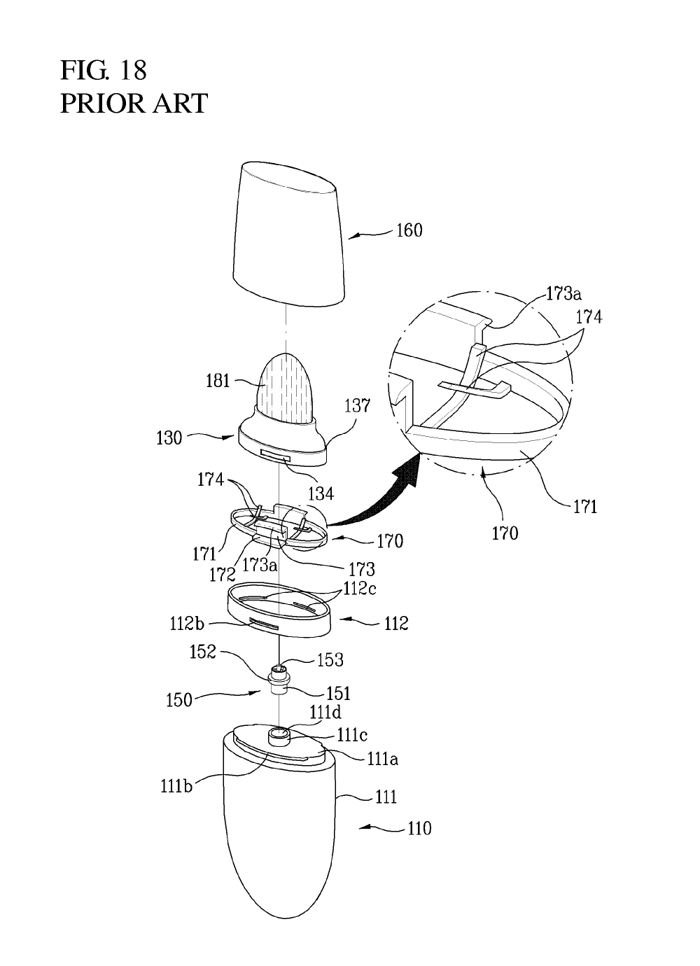

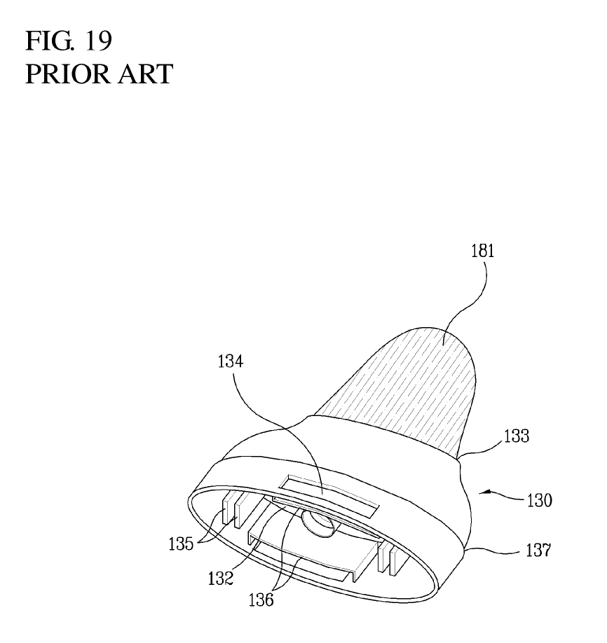

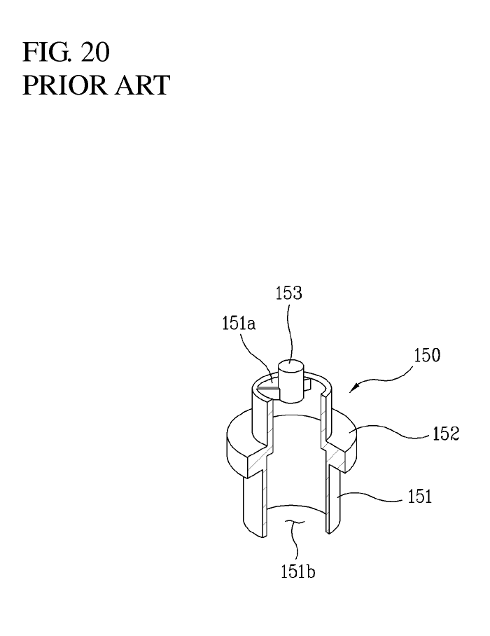

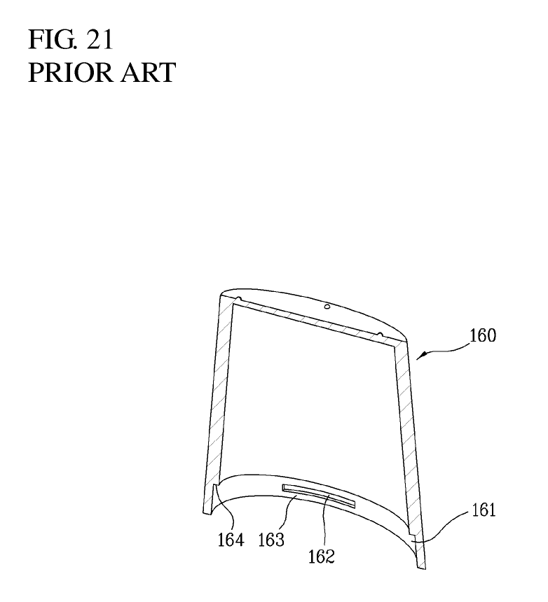

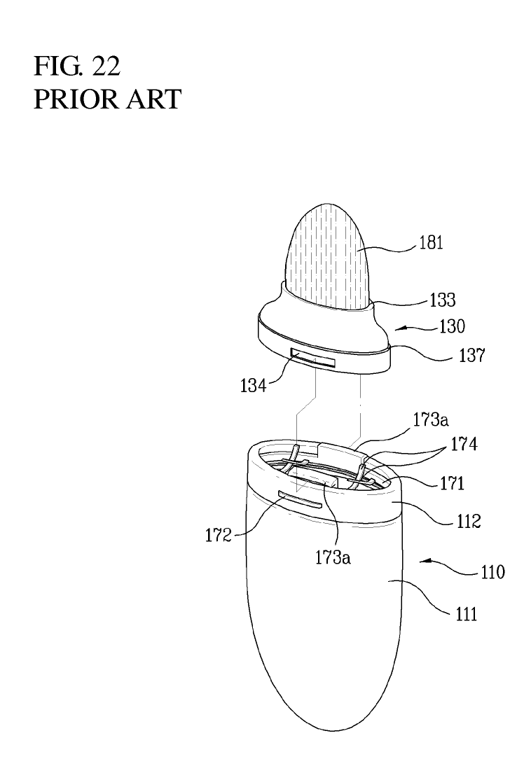

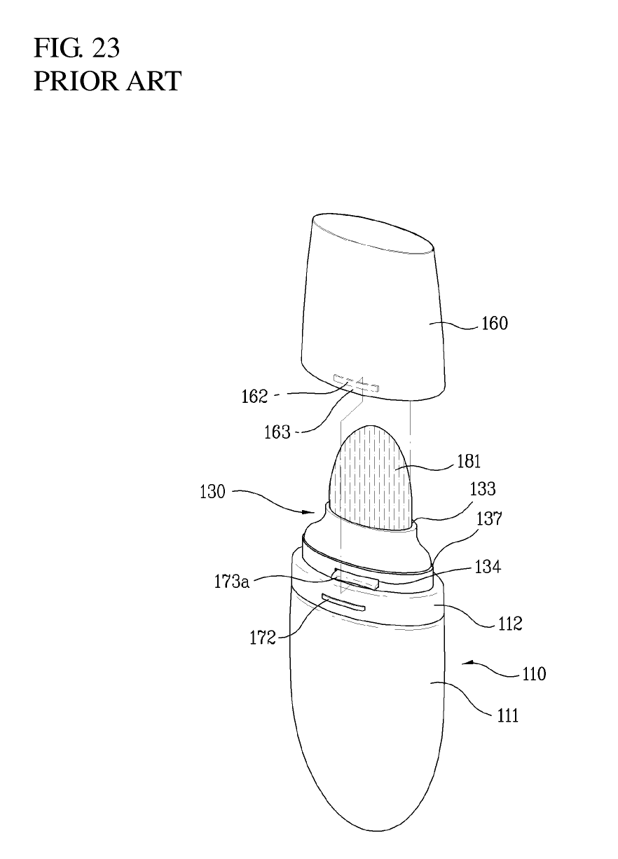

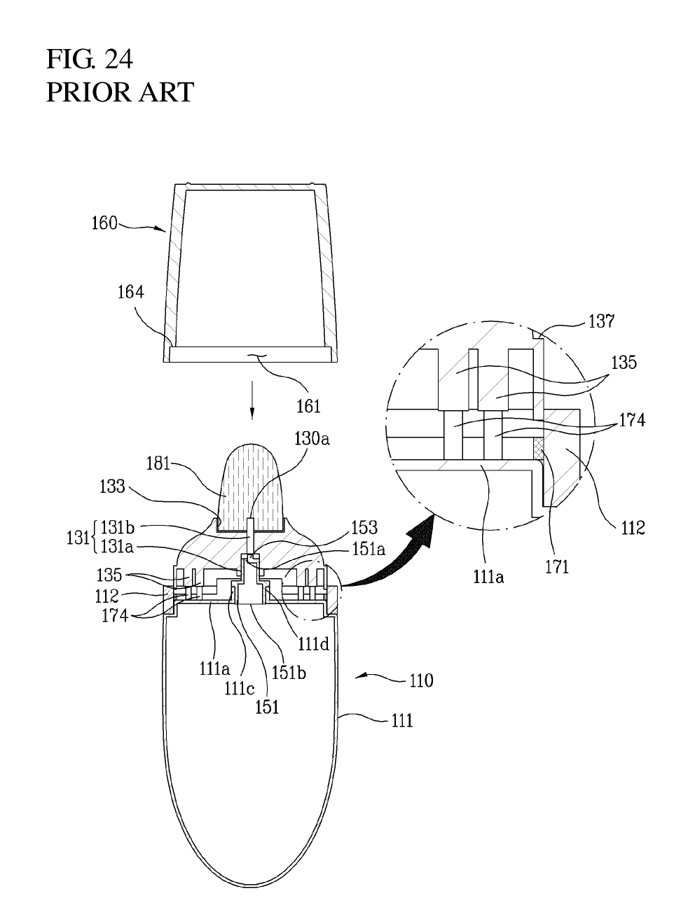

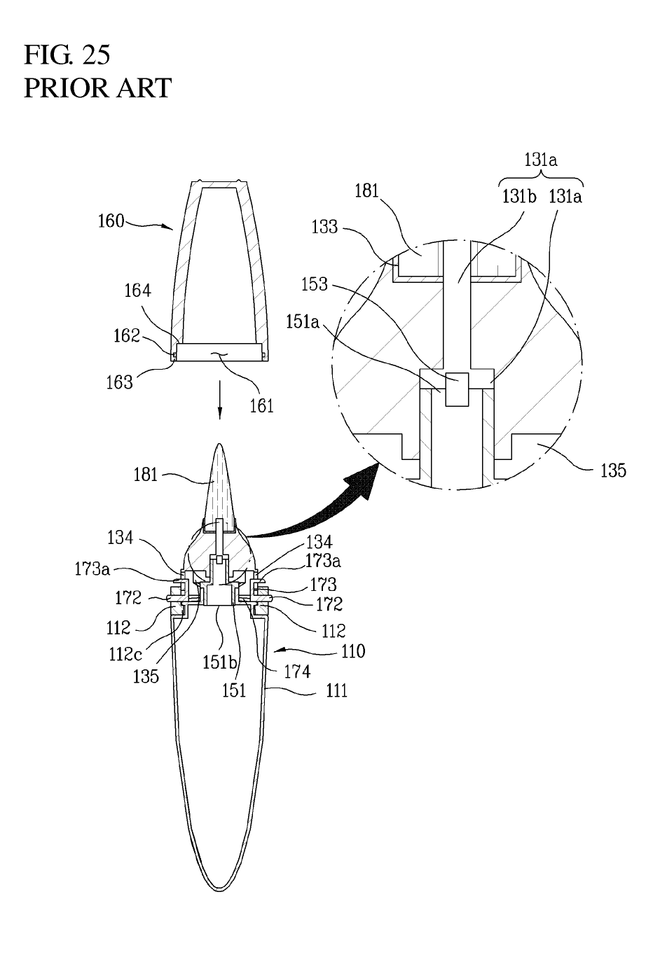

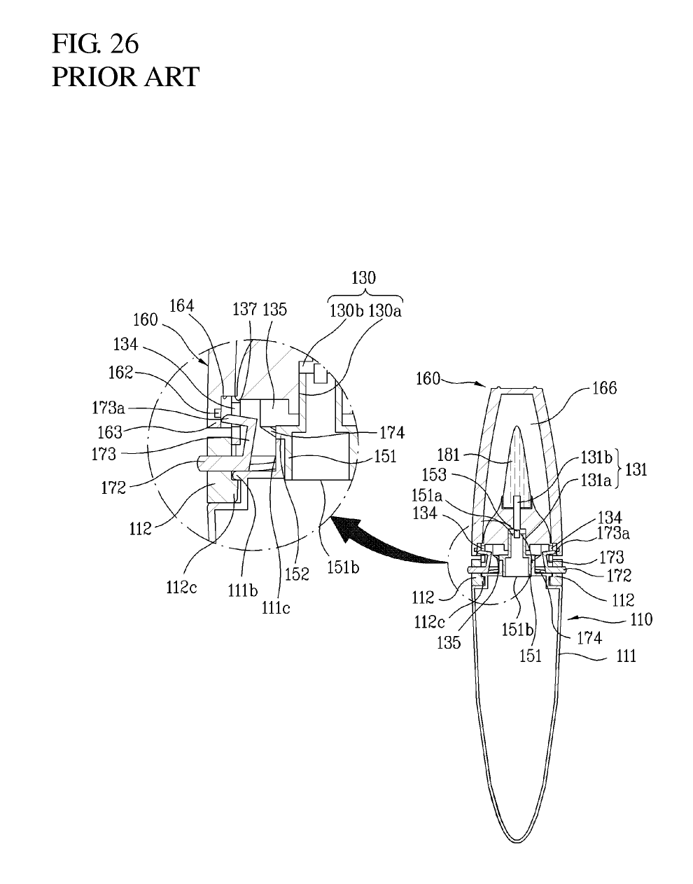

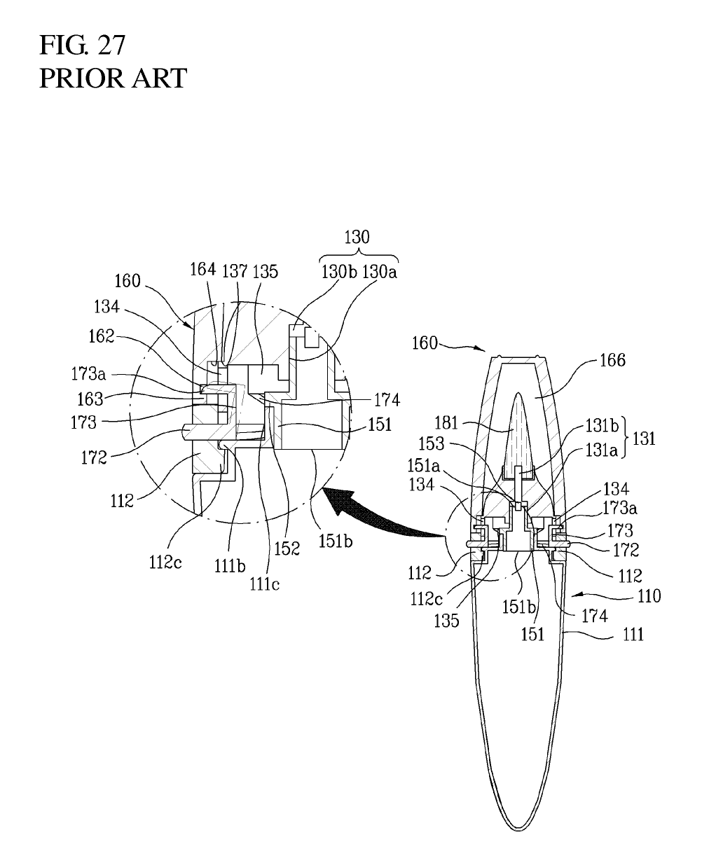

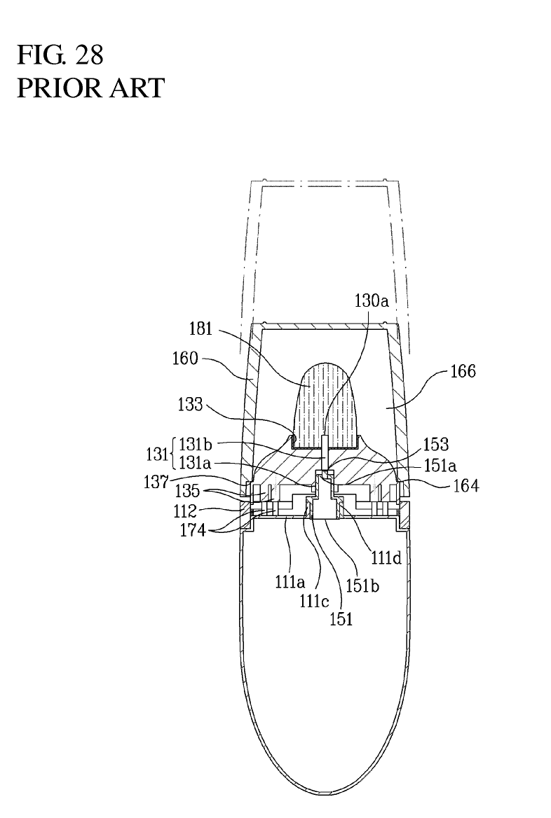

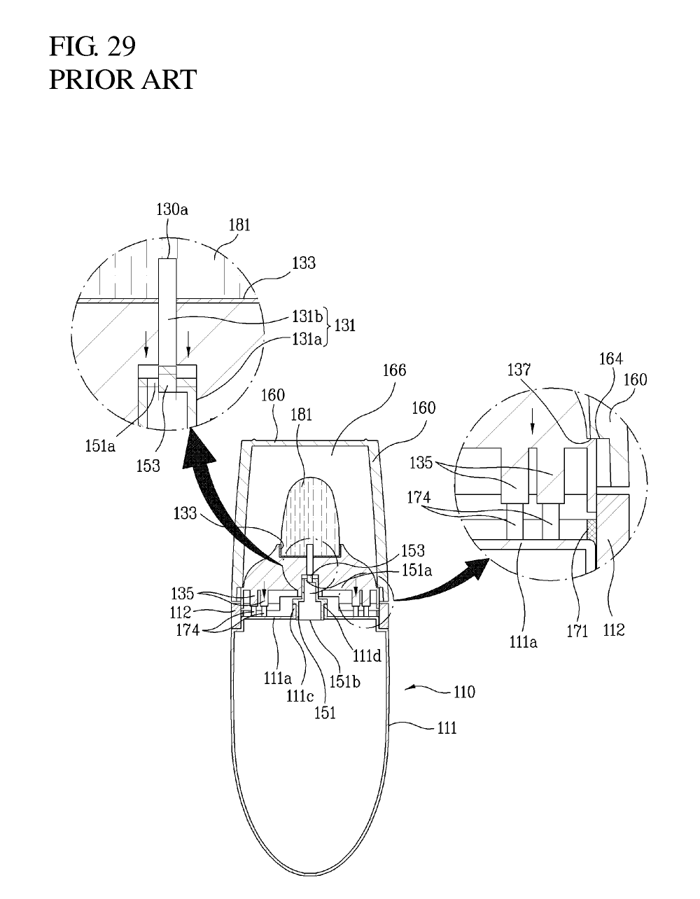

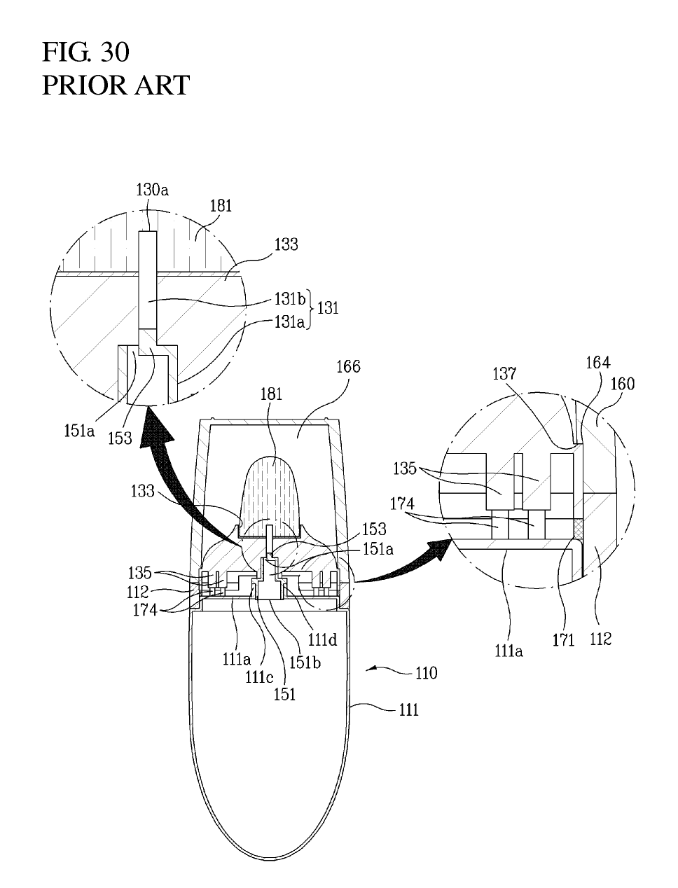

FIGS. 13 and 14 are cross sectional views of a container cap according to another embodiment of the present invention. FIG. 15 is a cross sectional view of the cosmetics appliance according to another embodiment of the present invention, in which the container cap is fitted to the container.

According to the embodiments of the present invention as described above, the holder 20 is designed to approach the container 10 along with the opening/closing section 70 when the container cap 60 is fitted to the container 10, thereby providing the following advantageous effects.

First, the structure of the holder 20 is simplified because the returning springs 72 is supported at the container 10.

Second, the durability of the opening/closing section 70 is increased because the movable plate 71 is not deformed while the holder 20 is approaching and moving away from the opening/closing section 70, and the returning springs 72 and the movable plate 71 are designed to be separated from each other.

Third, since the movable plate 71 is not deformed while the holder 20 is approaching and moving away from the opening/closing section 70, the movement operation of the holder 20 can be stably maintained.

In addition, since the spring holes 71b are formed in the movable plate 71, the operation of the returning springs 72 can be stably maintained.

Also, the condition of the applicator 81 installation can be stably maintained because the holder 20 is formed to be divided into the holder body 30 and the connecting member 40, as well as the applicator 81 is secured in the applicator fixing gap 44 formed between the holder body 30 and the connecting member 40.

Further, the discharging orifices 30a are formed to discharge the cosmetic product from one surface of the holder body 30, which enables loss of cosmetic product to be reduced.

Furthermore, the cosmetic product, having been passed through the discharging orifices 30a, can be delivered to the applicator 81 in a much larger amount because either the holder body 30 is formed in such a manner that the outer surface area 35a having the discharging orifices 30a is higher than the outer surface area 35b having the body seating recess 31a, based on the plate surface of the shape retaining plate 21, or the flow preventing walls 21a are formed in the shape retaining plate 21.

Furthermore, since the pressing pillar 61′ is designed to form the inner airtight space 66a around the applicator 81, the remaining cosmetic product in the applicator 81 can be prevented from hardening.

Consequently, according to the present invention, the holder is designed to approach the container, together with the opening/closing section 70, when the container cap is fitted to the container, which enables the structure of the holder to be simplified, the durability of the opening/closing section to be increased, and the movement operation of the holder to be stably maintained.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A cosmetics appliance comprising:
a container having a storage vessel and a shoulder connected at an upper end of the storage vessel, the storage vessel having an outflow exit formed on a top surface thereof, the shoulder being in the shape of a ring;
a holder having discharging orifices and a nozzle inserting recess, the discharging orifices and the nozzle inserting recess being formed to connect with one another, wherein the holder is disposed in such a manner that the nozzle inserting recess is directed toward the outflow exit;
an applicator connected to the holder in such a manner to receive a cosmetic product being discharged through the discharging orifices;
a nozzle having a discharging aperture and an inlet aperture, the discharging aperture and the inlet aperture being connected with each other, wherein the nozzle is disposed in such a manner that the inlet aperture is connected with outflow exit and the discharging aperture is opened in respect to the nozzle inserting recess;
a container cap fitted to the container in such a manner that the container cap forms an airtight space in cooperation with the container; and
an opening/closing section operable to move the holder toward the nozzle when the container cap is fitted to the container, so that the discharging aperture is closed in respect to the nozzle inserting recess, and operable to return the holder when the container cap is released from the container, so that the discharging aperture is opened in respect to the nozzle inserting recess,
wherein the shoulder has a release preventing rib formed inwardly from an upper end of an inner surface thereof,
the container cap has pressing pillars formed on an inner surface thereof, so that the container cap is operable to press the holder toward the storage vessel when the container cap is fitted to the container, and
the opening/closing section has a movable plate and returning springs, the movable palate disposed below the release preventing rib and having a nozzle insert hole formed at a central area thereof, the movable plate being connected to the holder so that the movable plate is operable to move toward the storage vessel along with the holder when the holder is pressed by the container cap, the returning springs being interposed between the movable plate and the storage vessel so that the returning springs are operable to be deformed while accumulating elastic force when the movable plate moves toward the storage vessel.

2. The cosmetics appliance according to claim 1, wherein the movable plate has spring holes formed vertically on an upper surface thereof, each of the spring holes supporting a respective one of returning springs.

3. The cosmetics appliance according to claim 1, wherein the holder includes a holder body having the discharging orifices and the nozzle inserting recess formed therein, a shape retaining plate formed at an upper end of the holder body, and a connecting member removably connected to the holder body in a manner to permit an applicator fixing gap to be formed between the connecting member and the holder body,
wherein the applicator is in the shape of a cap and is secured to the applicator fixing gap while being supported by the shape retaining plate.

4. The cosmetics appliance according to claim 3, wherein the discharging orifices are formed so as to allow a cosmetic product to be discharged through one surface of the holder body.

5. The cosmetics appliance according to claim 4, wherein the nozzle includes a nozzle body and a guiding protrusion formed at the upper end of the nozzle body, the nozzle body having the discharging aperture formed at an upper end thereof and the inlet aperture formed at a lower end thereof,
wherein the nozzle inserting recess is formed to be sectioned into a protrusion seating recess and a body seating recess,
wherein the holder body is formed in such a manner that an outer surface area having the discharging orifices is higher than an outer surface area having the body seating recess based on a plate surface of the shape retaining plate.

6. The cosmetics appliance according to claim 5, wherein the shape retaining plate has, at each of either side areas of the nozzle inserting recess, a respective one of flow preventing walls for preventing the cosmetic product discharged through the discharging orifices from flowing down toward a lower end of the holder body.

7. The cosmetics appliance according to claim 1, wherein the pressing pillars are formed to form an inner airtight space around the applicator in cooperation with the holder.
